(19) United States
(12) Patent Application Publication
(10) Pub. No.: US 2010/0250374 A1
(43) Pub. Date: Sep. 30, 2010

(54) KITCHEN MANAGEMENT SYSTEM

(75) Inventor: Thomas Downes, London (GB)

Correspondence Address: STITES & HARBISON, PLLC, 400 W MARKET ST, SUITE 1800, LOUISVILLE, KY, 40202-3352, US

(73) Assignee: QUAIL LIMITED, London (GB)

(21) Appl. No.: 12/526,155

(22) PCT Filed: Feb. 6, 2008
(86) PCT No.: PCT/GB2008/000425

§ 371 Date: May 18, 2010

(30) Foreign Application Priority Data
Feb. 6, 2007 (GB) 0702290.8

(51) Int. Cl. G06Q 50/00; G06Q 10/00; A47J 37/00; H04H 20/71

(52) U.S. Cl. 705/15; 705/301; 705/345; 99/325; 455/3.05

(57) ABSTRACT

A voice message system for use in kitchen management, particularly drive-thru restaurants, including a data processor (601); data storage means (601); a primary base station (102); a transmitter or other transmission means (501); a plurality of preset electronic messages; a plurality of receivers (101) adapted to reproduce one or more selected messages, transmit radio frequency messages and communicate between each other; and one or more ordering posts adapted to communicate with said kitchen management system. The messages are initiated at said ordering posts and then transmitted to the data processor (601) by the transmitter (501), said data processor converts the message into one of more preset messages transmitted to the master module (103) or a secondary module and then to the primary station (102) wherein the message is distributed to one or more receivers (101) or a speaker post system (105-112, 201-204). In addition, the system is capable of integrating means for recording and logging orders wherein orders are prioritised and then transmitted to a speaker module (105) wherein orders are reproduced audibly. Further, the system may comprise an electronically controlled apparatus for cooking food in response to a signal from the data processing means (601) and a lane timer (602) for detecting cars driving through the ordering posts.

The present invention relates to a voice message system in particular, but not exclusively, for use in drive-thru restaurants.

Drive-thru restaurants are increasingly busy, and as a result, communication and kitchen management systems have become invaluable for efficient service. The order point is the restaurants first point of contact with the customer and it is important that orders may be taken quickly and accurately. Drive-thru restaurants, therefore, require a clearly audible and reliable communication system. In addition, once the order is taken an internal communication and kitchen management system can be used to quickly assemble the order. The communication systems are typically used to communicate between the customer who is outside and between staff members in the kitchen operating the order point. Collecting an order may involve 10-12 members of staff simultaneously. They will be working under pressure in order to collate the order quickly and also performing other routine tasks. Many restaurants still rely on verbal and paper communication internally and attempts to introduce more sophisticated communication systems within the restaurant such as telephones, light signals, intercoms and bells have not generally been commercially successful.

Within the restaurant traditional communication between staff members experiences problems with precision and speed; further the signals used may be ignored or overlooked, consequently, the order operator has to repeat the signals often. Telephone and intercoms suffer from a high level of background noise from within the restaurant, making it difficult to hear the requests accurately. Telephone based systems also require someone to be present at the receiver when the request is being made thus they may interrupt the performance of a separate task. Furthermore, members of staff have to keep track of the food preparation facilities which often have timers with buzzers and lights and these signals may also be overlooked. Such overlooked orders or signals cause considerable delay in processing orders by customers and lead to a decrease in customer turnover. In addition, it is important for staff members to be able to work as a team to ensure that all the tasks are completed.

While customer turnover may be increased by adding extra drive-thru lanes, these require a substantial area, therefore, the area available for car parking is reduced, and, in addition, they necessitate a substantial investment for the restaurant because they essentially involve duplicating everything. Additional order points within a single drive-thru lane increase the complexity of taking and processing orders. Further, additional order points result in a higher number of staff members being required to handle a greater number of orders at any one time, thereby increasing the amount of communication required between kitchen staff, and the possibility of miscommunication or information being overlooked. Consequently, it is necessary to improve the processing of the order and flow of information within the restaurant kitchen in order to maintain a large turnover of customers.

Retail stores experience similar communication problems between staff and customers. Bells, buzzers and public announcement systems used to signal an event that needs attention can easily blend together and create a high level of background noise in the store. As a result the signals are easily missed. It would, therefore, be an improvement to integrate all the separate systems used between the shop floor and the warehouses and reduce the background noise in the store creating a more pleasant shopping environment and enabling staff to deal with events more efficiently.

The present invention seeks to provide an apparatus to improve the flow of information within the retail store or kitchen so as to speed customer turnover and to provide reminders to staff about routine operations and performance.

According to the invention there is provided a kitchen management system comprising a data processor and data storage means and data transmission means, the system being provided with a plurality of preset messages wherein when certain conditions are met the kitchen management system is adapted to send at least one of a plurality of the preset electronic messages to a receiver adapted to audibly reproduce the selected message or messages.

Preferably, the apparatus is adapted to reproduce the audio message using a radio headset. Preferably, the apparatus is integrated with a speaker post and kitchen management systems. Preferably, the headsets are assignable to a group and preferably, the audio message is audible to pre-selected groups of headsets. Preferably, the headset comprises means adapted to inform the system that a task has been completed.

The ability to integrate the system with the existing systems within the restaurant removes the need to retrofit substantial additional hardware, reducing the demand on costs. Fast food restaurant management systems represent a significant investment for restaurateurs and therefore it is important that any new technology is able to be integrated in a cost effective way.

In addition having kitchen management systems integrated with the external and internal communication systems means that only one headset is required for all systems. This means that messages may be managed so that they are not transmitted simultaneously leading to confusion, either interrupting a conversation between headsets or resulting in not being able to hear a single audio signal clearly as a result of two being transmitted simultaneously.

An exemplary embodiment of the invention will now be described in greater detail with reference to the drawings in which:

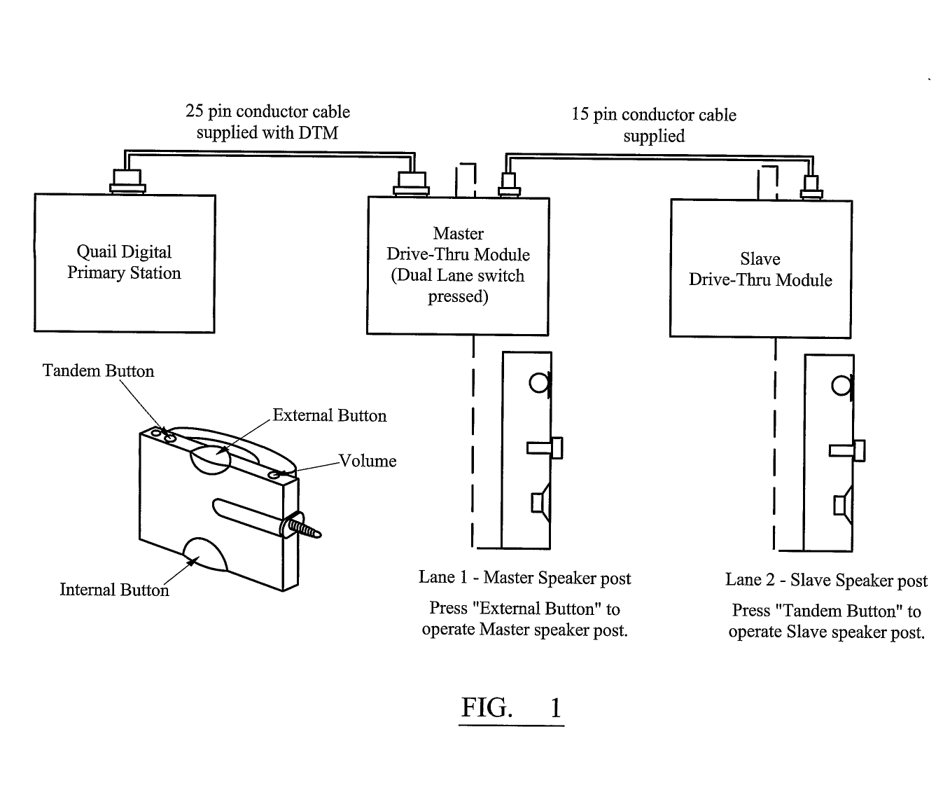

FIG. 1 shows a schematic diagram of a speaker posts linked to the primary station and a headset

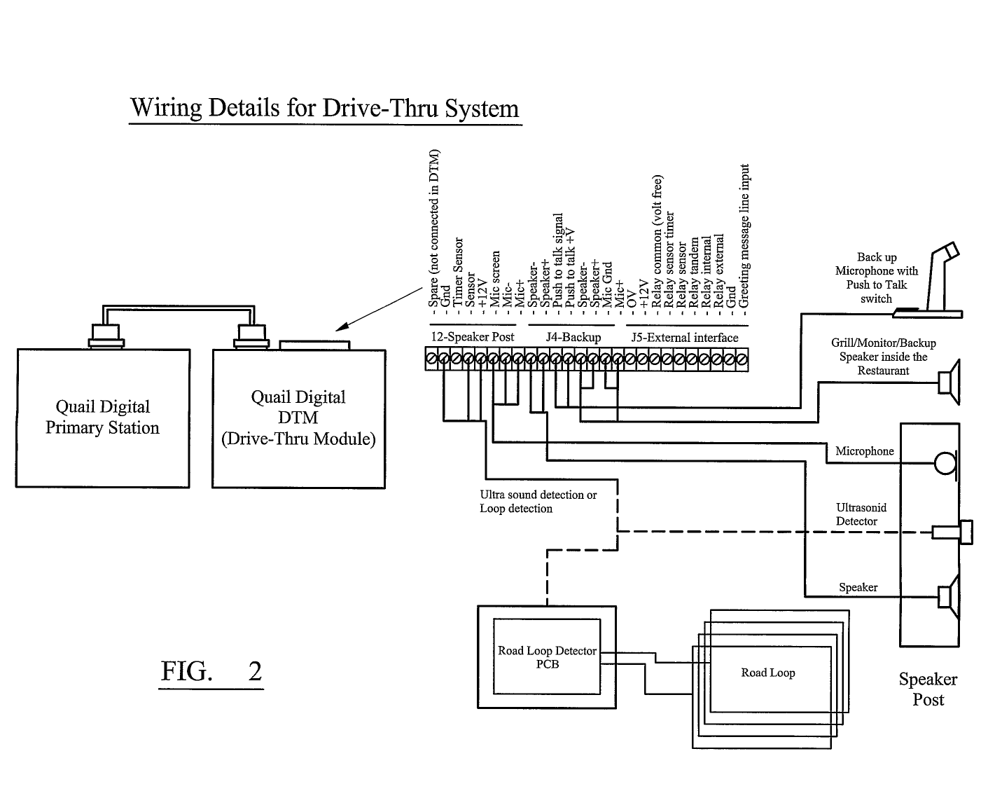

FIG. 2 shows a detailed diagram of speaker post and backup arrangement

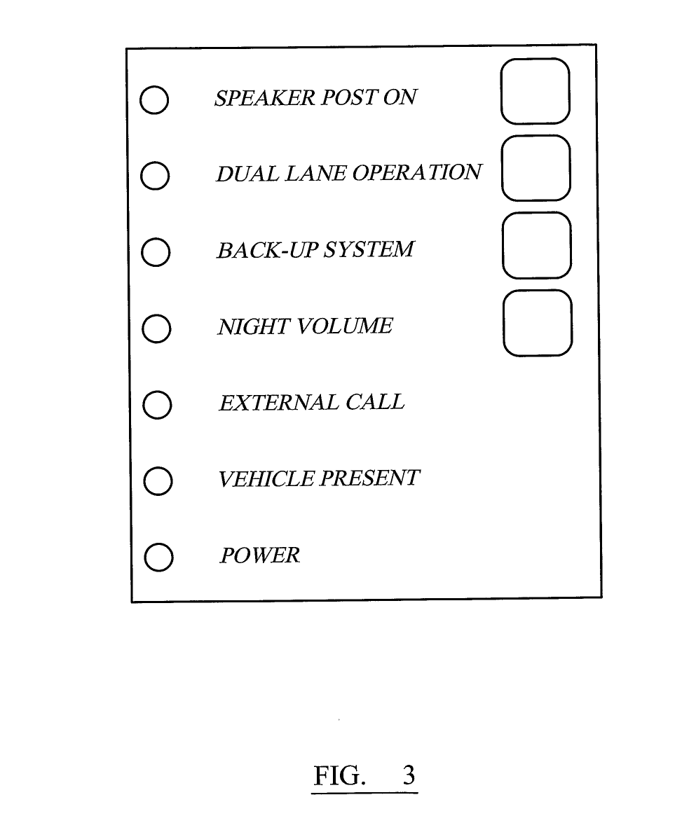

FIG. 3 shows a master drive-thru module

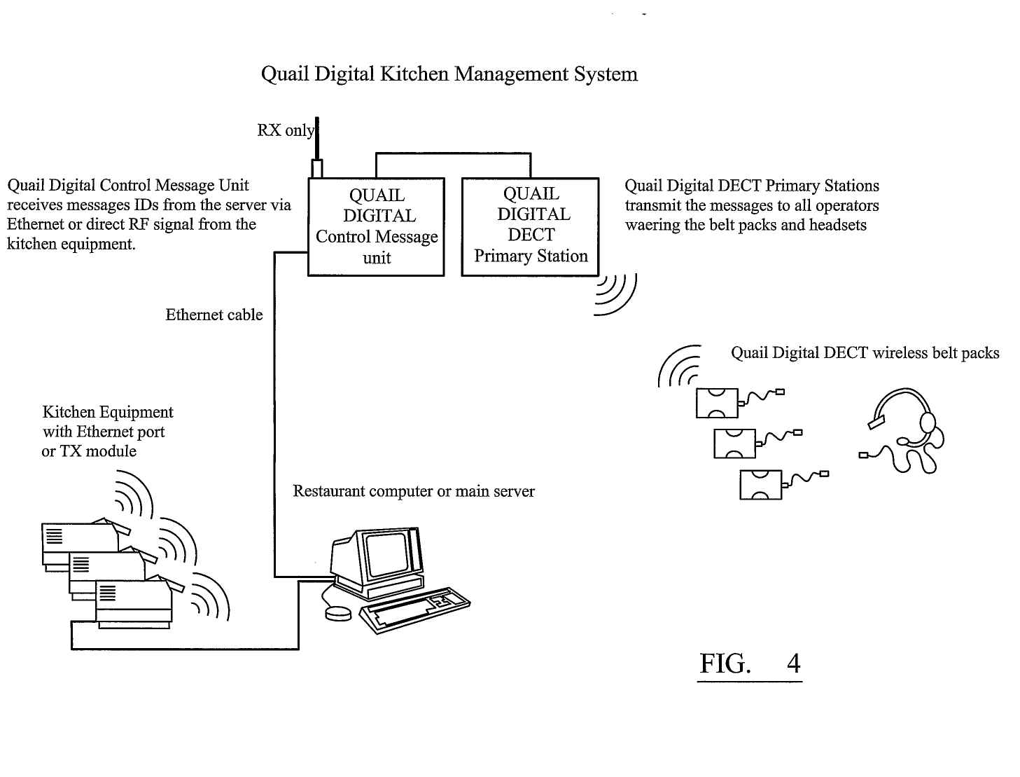

FIG. 4 shows a schematic diagram of integrated system

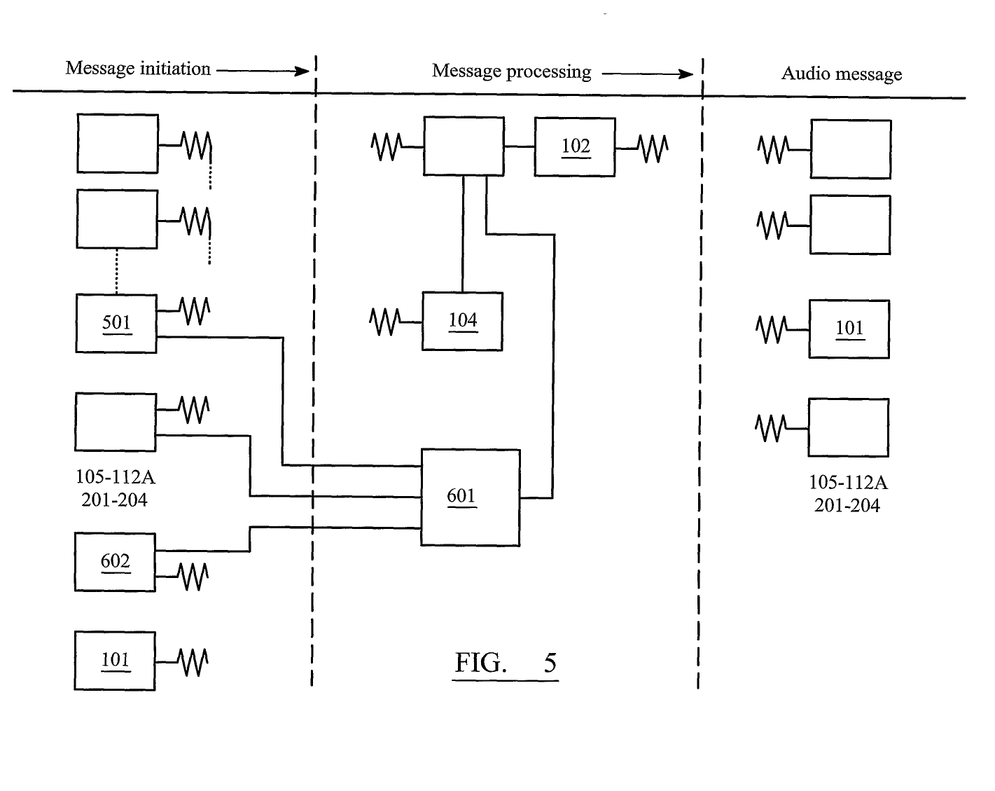

FIG. 5 shows a schematic diagram of integrated system with speaker post and lane timer

FIG. 1 shows an exemplary embodiment of a dual lane drive-thru arrangement integrated with a base station and headset audio system. The arrangement comprises a headset 101, a primary station 102, a master drive-thru module 103, a slave drive-thru module 104, and speaker posts 105, 106. The primary station 102, master module 103 and slave module 104 are located at a location remote from the speaker post within the restaurant kitchen. In use an operator using a headset 101 can communicate with a vehicle located in a drive-thru lane through the speaker post 105, 106. The speaker post further contains a microphone 107, 108, a loudspeaker 109, 110 and a vehicle detector 111, 112. The speaker is linked to the master module 103 which processes received signals to reduce the noise-to-signal ratio before transmitting the signal to the primary station 102. The primary station transmits an audio signal to a specific headset 101. In the case of a dual lane drive-thru a secondary speaker post 106 is linked to a slave module 104. The secondary speaker post 106 and slave module 104 are linked in a similar way to the link between the primary speaker post 105 and the master module 103. The slave module 104 is then linked to the master module 103 and the master module 103 processes received signals from the slave module 104 in a similar way to signals received from the primary speaker post 105. The headset 101 further comprises a tandem button 113 which may be used in order to communicate with the secondary speaker post 106. When communicating with the primary speaker post the external button 114 is pressed. Furthermore the headset operator can communicate with other headsets in the range of the primary station 102. By pressing the internal button 116 all the headsets 101 in the range of the primary station 102 may receive audio signals from the primary station 102 which originate from a single headset 101. Thus a single headset operator is able to communicate with one or more customers at different order points using buttons 113 or 114 and then collate the order efficiently by instructing colleagues in the restaurant kitchen by using button 116. The headset also has a volume control button 115. Communication between the headset 101 and the speaker post 105, 106 is duplex. This means that the operator is able to talk at the same time as the customer placing the order at the speaker post 105, 106 without loss of information as with simplex systems. In a simplex system only the speaker 109, 110 or the microphone 107, 108 may be operated as any one time, this leads to messages being cut off, or not being received at all, making clear and precise communication difficult.

As will be described below in relation to transmitters, radio headsets 101 are uniquely identified in a similar way. This enables them to identify audio messages received from the primary station 102 intended for individual headsets 101. If the message is not intended for a particular headset, then the message would not be reproduced. This also enables headsets 101 to be divided into groups, for example between several teams working within the restaurant or between cooking apparatus operators and supervisors.

FIG. 2 shows an exemplary embodiment of a single order point arrangement with a backup system for communication and vehicle detection. As before the speaker post 105 contains a microphone 107, speaker 109 and vehicle detection means 111 which are linked to the drive-thru module 103. The system further comprises a road loop 201 located in the pavement of the drive through lane and a road loop detector 202. When a vehicle is detected at the speaker post 105 by the vehicle detection means 111 or in the drive-thru lane by the road loop detector 202 a signal is sent to the drive-thru module 103. If there is a problem with the drive-thru module 103 a signal may be sent to the backup microphone with push to talk switch 203. The operator is therefore alerted to a customer vehicle in the drive-thru lane and can communicate through the headset 101 or back up microphone 203 with the speaker post 105. In addition the operator is able to communicate with kitchen colleges using the backup microphone 203 and back up speaker 204 which is located in the kitchen.

FIG. 3 shows an exemplary embodiment of the drive-thru master module 103. It comprises of light indicators 401 and manual switch buttons 402. The light indicators 401 indicate, “speaker post on”, “dual lane operation”, “back-up system”, “night volume”, “external call”, “vehicle present” and “power”. The manual switch buttons 402 can be used to manually over ride the system and switch the “speaker post on”, operate a secondary “dual lane operation”, switch on the “backup system”, and switch the speaker post volume to “night volume”.

FIG. 4 shows a schematic diagram of the integrated system with the kitchen management system using a restaurant computer of main server 601. The kitchen management systems which include a main server 601 are modified to include one or more radio transmitters 501 which are located within the kitchen area. The master module 103, and primary station 102 are located at a location remote to the kitchen management systems but within the range of the radio transmitters 501. The master module 103 is linked to the primary station 102 which transmits audio signals to the headset 101 or other audio speaker systems.

Each transmitter 501 has a unique binary code identification within the system that is set using DIP switches in the transmitter when the system is installed. The transmitter 501 is able to communicate with the base modules 103, 104 located within the range of a UHF signal. This aspect of the communication can be simplex, therefore the transmitters 501 are able to send radio packets to the base module 103, 104, but do not receive any radio packets. Simplex communication makes the kitchen management system easier to modify and reduces the cost of implementing the invention. In order to avoid messages not being received by the base module 103, 104 the same radio packet may be resent a number of times after a random delay by the transmitters 501.

When a kitchen management event occurs a radio packet is transmitted by a transmitter 501. The radio packet comprises a signal indicating which event has occurred and the ID of the location. The radio packet is received by the module 103, 104 and the main server 601 which decodes the message and the event ID and location of the transmitter 501. The module 103 then selects the appropriate MP3 pre-recorded audio messages which correspond to the event and the location, as specified by the business, which are transferred to the primary station 102 and transmitted from the primary station 102 to the headset receivers 101 or are connected to another audio speaker system. For example “cooker 3” for the identified location, and “batch finished” for the preset message that was triggered by the event. An audio transmission to the headset receiver 101 worn by kitchen staff enables the staff to be immediately alerted to the event and take further action. The precise selection of pre-recorded audio messages will be determined by the particular business and will depend on existing kitchen management systems and the needs of the business. For example training messages could be sent from the main server 601 at regular intervals reminding staff to wash hands every 30 min, to remind them to inform customers of special offers, or to prompt equipment operation. A restaurant computer or main server 601 could also keep track of necessary tasks and completed tasks. Preset messages can represent a particular task that may be logged by the computer 601 such as cleaning toilets. Once the task is completed by a staff member, a button on the headset can be pressed to send a confirmation that the task is completed. In that way if a task remains uncompleted within an appropriate length of time, another reminder message may be sent to both the original member of staff and a supervisor. This reduces significantly the possibility that tasks are not completed or that a message is missed.

FIG. 5 shows a schematic diagram of the integrated system with the kitchen management system and speaker post. The diagram shows the flow of information of an integrated system, such as that in FIG. 4 with radio transmitters 501 and headsets 101 and includes the speaker post system shown in FIG. 2. Transmitted messages are sent to the master module 103 to the primary station 102, and then audio messages are sent to the headsets 101 or speaker post system 109, 110, 204. To cover a wider area multiple modules 104 may be used. In certain applications it will be advantageous due to signal quality to use multiple modules 103, 104. Any transmissions received by a slave module 104 are sent via a cable to the master module 103. The master module 103 is also linked to the primary station 102 which transmits audio signals to the headset 101 or other audio speaker systems. Where necessary preset messages are also sent to the main server 601 for tasks to be logged.

A Lane Timer 602 may also be part of the existing restaurant system. A lane timer 602 is able to record the flow of customers in drive-thru lanes and process the information to detect real time bottle necks. Using information from the lane timer 602 the main server 601 can compare how long staff are taking to process orders to the flow through the lane, and where operations are taking too long could send a message to rectify the problem. For example messages such as “2^{nd} window too slow cooking” or “1^{st} window too slow on order” sent to a supervisor would allow for staff to be redistributed from elsewhere in the restaurant.

As already described the drive-thru module 103 is capable of receiving signals from the speaker post 105, 106, headsets 101, a lane timer 602 and kitchen management transmitters 501, thus integrating the kitchen management systems, internal and external communication.

Although we have described a system that includes a base station, the system could operate without such. A kitchen management system could be adapted to include a transmitter linked to the computer to send messages to the headsets. Also, if the order is being recorded by a kitchen management system then there is no need for the order point operator to communicate directly to kitchen staff members. Further, the system has been described in relation to a drive-thru restaurant, but it is equally applicable to any restaurant or bar. The system may also be used other environments such as in retail stores or hotels using headsets 101 and radio transmitters 501. Within different environments the preset messages and audio transmissions will vary depending on the needs to the particular business, but the integrated system will function in a similar manner.

1. A kitchen management system comprising a data processor, a data storage means and a data transmission means, the system being provided with a plurality of preset messages wherein when certain conditions are met the kitchen management system is adapted to send at least one of a plurality of the preset electronic messages to a receiver adapted to audibly reproduce the selected message or messages.

2. The kitchen management system according to claim 1 wherein the receiver is adapted to transmit and receive radio frequency messages.

3. The kitchen management system according to claim 1 wherein a plurality of receivers are provided, receivers being assigned to one or more of a plurality of groups of receivers.

4. The kitchen management system according to claim 2 wherein the receivers are adapted to communicate between each other.

5. The kitchen management system according to claim 1 wherein the receiver is a headset.

6. The kitchen management system according to claim 1 wherein the system is adapted to be integrated with one or more speaker posts such that at least one of the speaker posts is adapted to communicate with the kitchen management system, so that a message can be transmitted to the receiver.

7. The kitchen management system according to claim 1 wherein the system is adapted to be integrated with a lane timer such that when predetermined conditions are met the lane timer is adapted to communicate with the kitchen management system to enable a message to be transmitted to the receiver.

8. The kitchen management system according to claim 1 wherein the kitchen management system includes electronically controllable apparatus for cooking food such that when predetermined conditions is adapted to communicate the conditions to the system so that a message is sent to the receiver.

9. The kitchen management system according to claim 1 wherein the kitchen management system includes an apparatus for recording and logging orders such that the order is reproducible audibly.

10. The kitchen management system according to claim 2 wherein the kitchen management system is adapted to log tasks as indicated by kitchen management apparatus and the receiver is adapted to indicate to the kitchen management system when a task has been completed.

11. The kitchen management system according to claim 1 wherein the kitchen management system is adapted to manage a number of preset messages before they are reproduced audibly.

12. The kitchen management system according to claim 1 wherein messages are assigned a priority such that the kitchen management system is adapted to prioritise some preset messages over others such that a message with a high priority is transmitted before a message of low priority.

13. The kitchen management system according to claim 1 wherein the data processor and storage means comprises a master module and primary station, where a master module is a microprocessor and a primary station is a transmitter.
